(19) United States
(12) Patent Application Publication
(10) Pub. No.: US 2016/0358085 A1
(43) Pub. Date: Dec. 8, 2016

(54) SYSTEM AND METHOD FOR MULTIMODAL HUMAN STATE RECOGNITION

(71) Applicant: Sensaura Inc., Montreal (CA)

(72) Inventors: Mojtaba KHOMAMI ABADI, Montreal (CA); Jean-Philip RANCOURT POULIN, Saint-Nicolas (CA)

(73) Assignee: Sensaura Inc., Montreal (CA)

(21) Appl. No.: 15/173,443

(22) Filed: Jun. 3, 2016

Related U.S. Application Data
(60) Provisional application No. 62/171,359, filed on Jun. 5, 2015.

(51) Int. Cl. G06N 5/04; G06N 99/00

(52) U.S. Cl. CPC G06N 5/047; G06N 99/005

(57) ABSTRACT

An adaptive system and method are provided for modelling the behavioral and non-behavioral state of individual human subjects according to a set of past observations through sensed signals via a multi-modal pattern recognition algorithm. The system may take into consideration both subjective parameters that are learnt from the user over time, and contextual factors that are provided to the system, to achieve the model development.

### RELATED APPLICATIONS

This application claims the benefit of U.S. Provisional Application Ser. No. 62/171,359, filed Jun. 5, 2015, entitled “SYSTEM AND METHOD FOR MULTIMODAL HUMAN STATE RECOGNITION,” which is incorporated by reference herein.

### TECHNICAL FIELD

The following relates to systems and methods for performing multimodal human state recognition.

### BACKGROUND

Recent technological advances have enabled computers to monitor human users in ways previously unimaginable. The ability to understand different human states is desirable for the computer in several applications. Multimodal human state recognition systems may enable a computer to be more aware of the user's state, and respond accordingly.

### SUMMARY

A unified multimodal human state inference system that fuses the information content of input modalities and adapts the inference models to input parameters via user and/or context modeling and domain transfer learning is lacking. Moreover, such a system that enhances the quality of an input modality employing the other input contents has not been proposed.

The following provides a multimodal human state recognition system capable of: (i) fusing information content of multiple different modalities for better recognition quality, (ii) using different modalities to increase signal-to-noise ratio of other modalities, (iii) inferring contextual information and (iv) inferring subjective parameters. The system may use the contextual information together with subjective parameters to transfer the domain of input observations and adapt the trained systems for better recognition quality. The system may also learn its user over time to create user profiles that may be used to assist the inference of invariant and variant subjective parameters and contextual information.

The following therefore provides an adaptive system and method that models the behavioral/non-behavioral state of individual humans according to a set of past observations through sensed signals via a uni-modal or multi-modal pattern recognition technique. The system main take into consideration both subjective parameters that are learned from the user over time, and contextual factors that are provided to the system, to achieve the model development.

An embodiment of the invention as disclosed herein may include a system for determining a human state of a subject. The system may comprise a first modality data detection system configured to recognize first personal data of the subject indicative of the human state of the subject and a second modality data detection system configured to recognize second personal data of the subject indicative of the human state of the subject. The system may further comprise a computer system comprising one or more physical processors programmed by computer program instructions that, when executed, cause the computer system to receive first personal data and second personal data from the first modality data detection system and the second modality data detection system, determine first modality data from the first personal data, determine second modality data from the second personal data, determine first human state information by a first expert system according to the first modality data, determine second human state information by a second expert system according to the second modality data, combine the first human state information and the second human state information by a decision gate to determine fused human state information of the subject, and provide the fused human state information of the subject to an output system.

In some implementations, the first modality data detection system may be further configured to obtain first contextual information of the subject and the computer system may be further caused to determine a contextual state of the human subject by a contextual information agent according to at least the first contextual information.

In some implementations, the computer system may further include a selective database repository including information associating recorded modality data samples with human state labels, and the computer system may be further programmed to generate a first generic inference model of the human subject based on information stored in the selective data repository, and the first expert system may determine the first human state information according to the first generic inference model of the human subject.

In some implementations, the computer system may be further programmed to update the first generic inference model to obtain a first adaptive inference model specific to the subject based on at least the first human state information.

In some implementations, the computer system may be further programmed to determine at least one subjective user parameter based on at least one of the first modality data and the second modality data, and update the first generic inference model to obtain a first adaptive inference model specific to the subject based on the first human state information and the at least one subjective user parameter.

In some implementations, the subjective user parameter may include at least one of a temporally variant parameter and a temporally invariant parameter.

In some implementations, the computer system may be further programmed to remove noise in the second modality data based on analysis of the first modality data.

In some implementations, the computer system may be further programmed to remove noise in the first modality data based on at least one of contextual information and a user profile.

In some implementations, the computer system may be further programmed to determine the first modality data from the first personal data by a domain transfer from an unknown modality having fewer labeled data samples stored in the selective data repository to a known modality having a greater number of labeled data samples stored in the selective data repository.

In a further embodiment of the invention as disclosed herein, a method of recognizing a human state of a subject is provided. The method may comprise recognizing first personal data of the subject indicative of the human state of the subject by a first modality data detection system, recognizing second personal data of the subject indicative of the human state of the subject by a second modality data detection system, receiving first personal data and second personal data from the first modality data detection system and the second modality data detection system by a computer system comprising one or more physical processors programmed by computer program instructions, determining, by the computer system, first modality data from the first personal data, determining, by the computer system, second modality data from the second personal data, determining, by the computer system, first human state information by a first expert system according to the first modality data, determining, by the computer system, second human state information by a second expert system according to the second modality data, combining, by the computer system, the first human state information and the second human state information by a decision gate to determine fused human state information of the subject, and providing, by the computer system, the fused human state information of the subject to an output system.

### BRIEF DESCRIPTION OF THE DRAWINGS

Embodiments will now be described by way of example only with reference to the appended drawings wherein:

FIG. 1 is a schematic diagram of an exemplary human state recognition system interacting with sensors coupled to a user;

FIG. 2(a) is a schematic diagram of an exemplary implementation of the human state recognition system in a personal device;

FIG. 2(b) is a schematic diagram of an exemplary implementation of the human state recognition system;

FIG. 3 is a block diagram of an exemplary configuration for the human state recognition system;

FIG. 4 is a block diagram of an exemplary configuration for a generic model agent;

FIG. 5(a) is a flow chart illustrating exemplary operations performed in generating a human state output using a generic model;

FIG. 5(b) is a flow chart illustrating exemplary operations performed in generating a human state output using a generic model and including contextual information extraction;

FIG. 6 is a block diagram of an exemplary configuration for an adaptive human state recognition system;

FIG. 7 is a block diagram of an exemplary configuration for an adaptive model agent;

FIG. 8(a) is a flow chart illustrating exemplary operations performed in generating a human state output using an adaptive model; and

FIG. 8(b) is a flow chart illustrating exemplary operations performed in generating a human state output using an adaptive model and including domain transfer.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the HSRS 10, any component of or related thereto, etc., or accessible or connectable thereto. Any application or module herein described may be implemented using computer readable/executable instructions that may be stored or otherwise held by such computer readable media.

The system described herein relates to methods and services for personalized recognition of human state upon the availability of input source(s) of information (i.e. different modalities) for the collection of status-clues through the fusion of information. Status clues can be collected through peripheral physiological signals, voice, face, brain waves, body pose, gestures, and other human characteristics, events, and/or data. Such information can be sensed by a set of sensors (or other data acquisition devices or modules), and fed to a state recognition system that interprets the information for the inference of human-state measures.

As used herein, human state refers to the cognitive and/or physical state of human subjects. Human cognitive state refers to the state of a person's cognitive processes that defines his/her state of mind. This may include, but is not limited to (i) emotions, mood and interestedness (ii) amnesia, memory loss, blackout i.e. partial or total loss of memory; (iii) paramnesia (a disorder of memory in which dreams or fantasies are confused with reality), (iv) readiness or set (being temporarily ready to respond in a particular way) (v) consciousness , (vi) confusion, i.e., a mental state characterized by a lack of clear and organized thought process and behavior, (vii) certainty, (viii) uncertainty or doubt, (ix) preoccupancy, preoccupation, engrossment, or absorption, i.e., the mental state of being preoccupied by something, (x) inwardness, i.e., the preoccupation with one's one attitudes and ethical or ideological values; (xi) outwardness, i.e., the concern with outward things or material objects as opposed to the mind and spirit, and (xii) morbidity, i.e., an abnormally gloomy or unhealthy state of mind.

Human physical state refers to a set of human body configurations that determine a concept, activity and/or a behavior. The set may have temporal variation so that it involves changes in body (limbs) responses over time that determine a certain concept, activity and/or a behavior of the person. Activity may refer to what a person is doing or interacting with (i) in a daily basis, (ii) as a task, (iii) in physical organized activities. The concept and behavior could refer to the physical or mental health of a person, e.g. (i) abnormal gait patterns that relate to central nervous system disorders, (ii) medication ingestion impacts, (iii) a person being physically damaged, (iv) a person being drunk or under the impact of using drugs, (iv) a person committing to a crime or serial killer behavior (v) a person committing to security related abnormal behavior, (vi) a person committing to abnormal social behaviors and/or violent activities due to socio-psychological disorders.

Human state information may be collected by one or more modalities. As used herein, modalities refer to sources of input information. Different modalities may collect information via different hardware (e.g., sensors, cameras, etc.) based on different measureable quantities. A modality may refer to an input source of information for a system from which to perform a certain process to provide a useful output (processed) information, and/or make a decision. Therefore, modalities may be any source of raw and/or processed information. A modality may thus refer to (i) a sensor device that senses a set of information to make available the sensed information to the system or (ii) a set of information channels that is available as input information for the system. In the latter case, most often, the set of information channels are provided by other systems and they are the output of other systems. For instance, in a system for emotion recognition from physiological signals, an ECG sensor could be considered as a modality as it senses the electrocardiography signal of the user and provides it as a source (input) of information to the processing system.

Various Modalities may have overlap of information content so that they may induce some degrees of redundancies when they are made available to the systems at the same time. However, such overlapping modalities may also have complementary information to assist the system with its information processing. In case two modalities have exactly the same information content to a system, they may be used only to make the system noise tolerant (i.e. when one channel gets noisy and the other does not). For instance heart-rate measured from right wrist blood volume pulse (BVP) and left wrist BVP may be considered the same. However, do to subject movement, signal to noise ratio between the two may vary.

Modality data may be provided to individual expert recognition systems, which may be used to determine human state information from input raw data collected through the input modalities. The decisions of individual expert systems may be fused (i.e. via a decision fusion operation) to maximize the employment of the information content from all modalities. Moreover, each individual expert system may, over time, learn the behavioral model of a specific user by adaptive learning methods. The user-specific behavioral model may be used to better extract the status cues and improve the reliability of recognitions. Each system user may have a corresponding adaptive inference model that is updated to improve human state recognition.

The human state recognition system (HSRS) described herein may be implemented in various applications, some examples of which are provided below, without limitation.

In an exemplary implementation, an adaptive emotion recognition system may be provided, which tracks the emotional state of users by sensing psycho-physiological signals through multi-sensory inputs. Such a system may use different sensors to capture emotional cues in behavioral and non-behavioral signals captured from a user to recognize the emotion of the user at a certain time. Signals that may be used to determine the emotion of a user may include, for example: voice signals, heart activities, brain activities, electro-dermal activities, muscular activities, respiratory patterns, blood factors (sugar level, hormones levels), posture, gestures, environmental interactions, and other suitable factors.

An HSRS, as provided herein, may be trained to predict the human state, or emotion, of a new user, based on a generic model. A generic model may include a generic predictive probabilistic model trained from a repository of labeled and unlabeled previously recorded data system to predict the emotion of a new user given an input set of one or more modalities. Such a system is a generic system that uses the complementary information of different input modalities to predict the emotion of a new user. The HSRS may then adapt to the new user, and may model subjective parameters specific to the user via different machine learning approaches such as instance-learning and re-enforcement-learning. In other words, the system learns how to best tune the parameters of its pattern recognition algorithm to achieve high performance on emotion prediction for its current user.

As used herein, Subjective Parameters may refer to human-subject-dependent factors that have impact on the information flow of the system. Subjective parameters may be made available to the system by other systems (or by parts of the original system) via a set of modalities. A subjective parameter may be information that has an impact on the information flow of the system. Subjective parameters involve information that relates to inter-subject differences and do not involve information that relate to intra subject differences, i.e. contextual information. For example, an individual personality of a subject may have an impact on the emotion of a person.

Subject parameters may include both temporally variant and invariant parameters. In the field of emotion recognition from psycho-physiological signals, examples of temporally variant parameters may include the amount of nicotine, caffeine in the blood or the activity that a person is doing such as running, sleeping. Invariant parameters in the same field may cover more subjective parameters such as personality, temper, and the gender of the user.

In an exemplary implementation, an HSRS may learn the baseline heart rate of a user in a neutral emotional state. Different users may have baseline resting heart rates that vary considerably. When determining human state based on heart rate, knowledge of a resting heart rate may be crucial. For example, a heart rate of 90 beats per minute for one subject may be indicative of excitement, while, for another subject, such a rate may be at or near a baseline resting rate.

Additionally, the HSRS as described herein may use contextual information about a subject at the time when modality data is recorded. Contextual information may complement the input modality data with respect to the process of information within the information flow of the HSRS. Contextual information may provide extra information that is often needed to choose/modify/adapt specific processes in information flow of a system to output certain information. Contextual information may include the identity of factors that relate to input information from modalities, e.g., associated with people, places, motion, etc. Contextual information may also include information about factors related to the available modalities, e.g., signal structure model, dates, geographical locations, etc. In some implementations, contextual data may be obtained from data recorded by a modality detection system, while, in other implementations, contextual information may be supplied by alternative data sources.

For example, the location of a person could relate what the person may be doing in an activity recognition system, e.g. if a person is in a swimming pool certain movements may relate to sliding, diving, or swimming, whereas, similar movements of the person outside of a swimming pool may have an entirely different meaning.

Continuing the heart rate example discussed above, there are several changes that may occur in a subject's heart rate that are not indicative of emotional human state. For instance, whether the subject is walking outside or seated in his/her office could be considered for a more accurate prediction, because, for example, the baseline heart rate measures of a user at the neutral emotional state, when the person is walking or seated are different. Therefore, a heart rate based emotion recognition system that uses the heart-rate values directly, may also consider the contextual information.

In another implementation, the HSRS may use multi-sensory inputs, including video streams, sound signals, near-infra-red signal streams, physiological data, mobile data, and other suitable data sources as input sources to recognize what a user is doing at a certain time. In this case the state of the human is the activity that the person is engaged in. A multi-modal system, at the beginning of usage, may be trained on a social repository that includes labeled and unlabeled data samples from other humans in similar environmental conditions. Such a system may be a generic system that over time evolves according to the user and contextual data to create a user-specific inference model. Over time, the system may adapt to different subjective and contextual I parameters. The system may learn the subjective parameters for better activity recognition predications through an active learning approach. The learned subjective parameters may be used to update and adapt the user specific inference model according to the user.

Moreover, the HSRS may estimate some contextual and or environmental parameters that may be used to filter the former observation to obtain a more accurate predictive probabilistic model. For example, some of the contextual information (such as the objects that a person is using at a time) may be directly used for a more accurate prediction. While using both generic and adaptive models, the system may exploit the complementary contextual information content received via different modalities for a better prediction. For instance, if the subject is lying on a sofa in front of a TV that is on a comedy channel and the person is laughing and physiologically stimulated, then most probably, the person is watching the TV. If the same subject is not laughing and is very relaxed then it can be predicted that the person is sleeping on the sofa.

Environmental parameters refers to human-subject-independent factors that have an impact on the information flow of the system. Environmental parameters may include aspects of a user's environment that have an impact on the information flow of the system regardless of whether they are available to the system or not. Environmental parameters sensed by the system (or a provided to the system by third party sensors) may become contextual information. For example, speed of a person may have an impact on recognition of the activity of a person, but the system may lack this information as contextual information. When the person's speed is sensed, it can then be used by the system as contextual information. The darkness of the environment may have an impact on the emotion of a person but may not be available to the system as contextual information if the ambient light is not sensed by a modality detection system.

In yet another exemplary implementation, a human compulsive state recognition may be provided. Human compulsive state recognition may use information from physiological sensors and environmental data provided by smart objects that are interconnected (e.g., internet of things) to characterize single habits, and where the system would interact accordingly to the action wanted. Such a system may be a generic system that may use the complementary information of different inputs from the user state and the environment to predict habits of a new user. Such a system may evolve over time according to subjective user data and contextual data. In other words, over time, the HSRS model may be adapted to different subjective and contextual parameters. The system may learn the subjective parameters for better habit recognition predictions through an active learning approach. The learned subjective parameters may be used to update/adapt the predictive model according to the user and the location. For example, a person may have a craving for candy (an unhealthful choice) after watching TV for more than three hours in a row (environment/context). The system may recognize the bad habit (eating unhealthy snacks while watching TV) and interact with the person to propose a better alternative or distract the person toward a healthier choice, either before the craving happens or concurrently with the craving. Similar protocols may be applied for avoiding other bad habits (smoking, drinking, taking drugs, etc.) as well as promoting good habits (exercise, cleaning, helping, etc.).

In other exemplary application, a user may be a human whose state may be monitored by an intelligent system over time through different means as input modalities. The state of the user is a condition among several possibilities that can be associated to a user given the user's cognitive and behavioral relation with environmental elements. The system may use a generic model for the prediction of the user's state when it is first applied to a user and over time improves the prediction by learning and applying a user-specific model. Related applications may include various human monitoring and human behavioral understanding applications such as patient monitoring, human activity recognition, and human emotion tracking. The HSRS described herein may offer features that provide multi-modal HRS to rigorously predict the human state via the fusion of human state information generated via a plurality of modalities that are adaptive to the user parameters and contextual information.

To further illustrate the principles employed by the HSRS described herein, an exemplary application scenario, an adaptive multimodal emotion recognition system is provided. In an emotion recognition system, the emotional state of a user is his/her human-state. The possibilities for emotional states may be considered according to the specific application. In a general case, emotional states may be defined as the level of intensity of six basic emotions: fear, excitement, surprise, disgust, happiness and sadness. In another example, emotional state may be characterized by the levels of arousal (excitement), valence (pleasantness), engagement and dominance (control). As such, it may be appreciated that the definition of “human state” as herein used is flexible and application dependent and specific. For example, the emotional state of a user in a particular application such as stress recognition may only consider the level of stress. States may be defined qualitatively or quantitatively. Qualitative states of emotions are used when the presence or absence of certain emotion categories/classes in a user is the matter of question. On the other hand, quantitative states of emotions are employed when the intensity of an emotion categories/classes/dimensions in a predefined range of numbers is to be measured.

The various implementations of the invention described above may be implemented by a human state recognition system (HSRS), as described in greater detail below with respect to the figures.

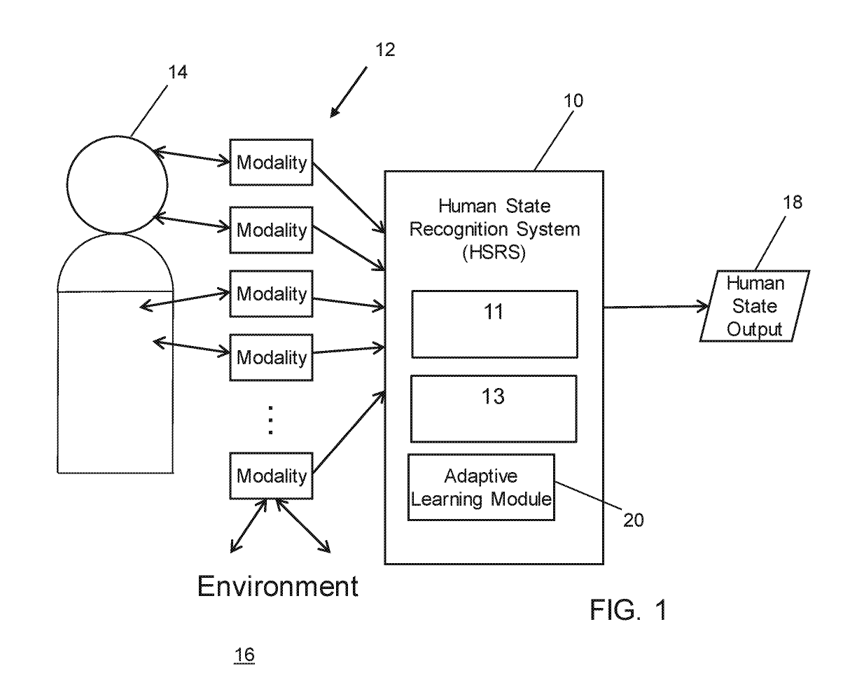

FIG. 1 illustrates a human state recognition system (HSRS) 10 programmed to receive physiological, environmental, subjective and/or contextual data from multiple modality detection systems 12 related to or associated with a user 14 and/or his/her environment 16. Such data may collectively be referred to herein as personal data. The HSRS 10 may use a combination of modality detection systems 12 to generate a human state output 18 that may be used for a particular application, e.g. as outlined above. HSRS 10 may also include a module or capability or functionality for adaptive learning 20 to adapt a generic model of a user to an adapted inference model specific to the user.

Modality detection systems 12 may be configured to detect, sense, and/or otherwise capture personal data associated with a human state of a subject. Input modalities captured by modality detection systems 12 may include, but are not limited to : facial videos, heart activities, brain activities, galvanic skin response, skin temperature, muscular activities, blood sugar intensity, respiratory patterns, blood oxygenation, blood pressure, iris changes, eye movement, eye blinks, eye gaze, blood factors, voice, posture, gesture, pressure, and other sources that may include emotional cues.

Additional input modalities that include emotional cues may be related to behavior of humans, including but not limited to: messages that humans produce for communications, diary content, interaction with intelligent and non-intelligent environmental elements such as computers, daily living devices, and cars. An example of an interaction with an environmental element that involves emotional cues is the amount of pressure a person uses to keep a pencil in his hand while writing a note on a postal card.

HSRS 10 may be implemented as a computer system on a server (e.g., having one or more server blades, processors, etc.), a gaming console, a handheld gaming device, a personal computer (e.g., a desktop computer, a laptop computer, etc.), a smartphone, a tablet computing device, and/or other device or devices that may be programmed to perform all aspects of human state recognition described herein. In some exemplary implementations, HSRS 10 may be implemented across multiple devices, for example as a personal device configured to collect and perform modality data pre-processing and a remote server device configured to process the modality data to provide a human state output.

HSRS 10 may include one or more processors 112 (also interchangeably referred to herein as processors 112, processor(s) 112, or processor 112 for convenience), one or more storage devices 114, and/or other components. Processors 112 may be programmed by one or more computer program instructions.

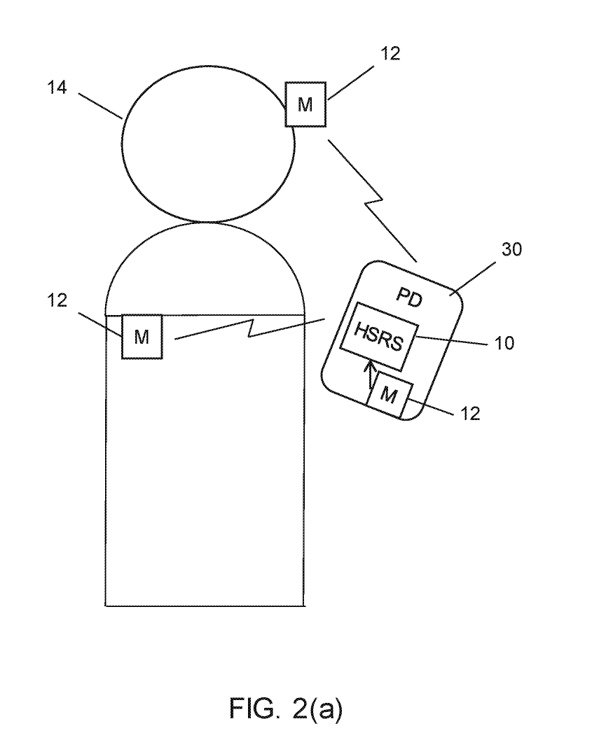

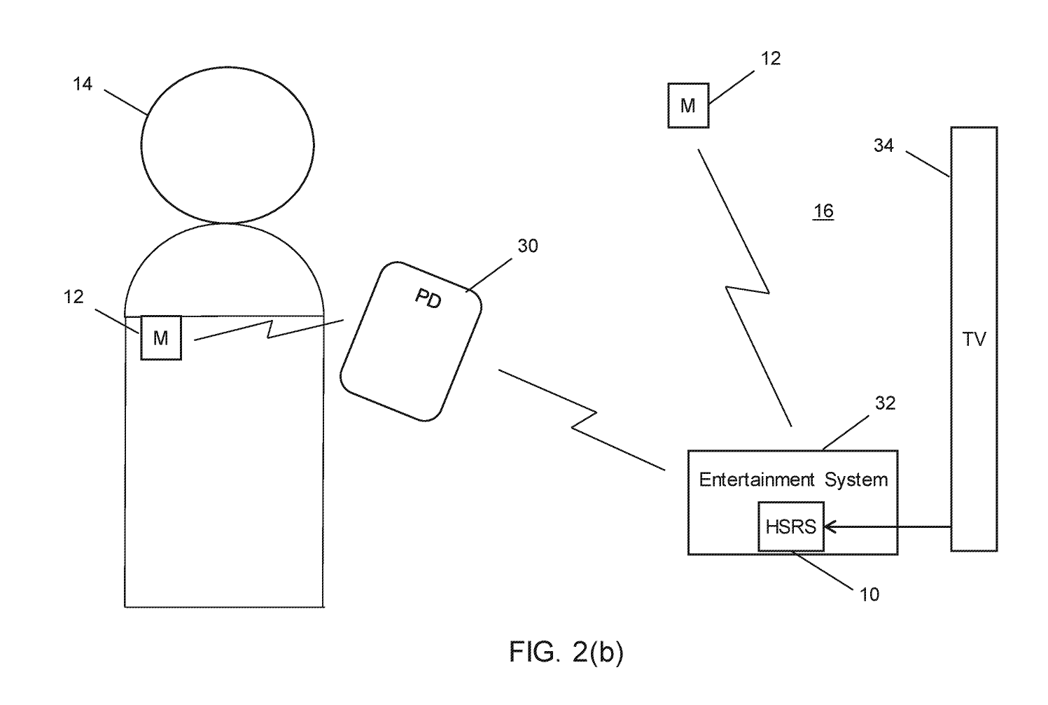

As illustrated in FIG. 2(a), HSRS 10 may be included in a personal device (PD) 30 such as a smart phone, tablet computer, laptop, personal gaming device, smart watch, or other portable user device. PD 30 may be capable of wirelessly, e.g., via Bluetooth, wi-fi, or other wireless protocol, receiving data from one or more modality detection systems 12 that are coupled to or capable of sensing parameters or events on, in, and or around user 14 (e.g., via sensors or other detection methods), in order to feed this data to HSRS 10. Furthermore, one or more modality detection systems 12 may be included in PD 30, and may enable HSRS 10 to detect interactions with PD 30 or the environment 16 (e.g. via camera or microphone).

FIG. 2(b) illustrates another exemplary configuration of HSRS 10. In FIG. 2(b), HSRS 10 is included in a device within environment 16, for example as an entertainment system 32. In this exemplary configuration, HSRS 10 may use various available devices and methods within environment 16 to gather modality input data. For example, a modality detection system 12 on the user (e.g., heart rate monitor) may communicate with the entertainment system 32 via PD 30 (or directly—not shown). Similarly, a modality detection system 12 within the environment 16 such as a microphone array, camera, temperature sensor, etc. may also be used to provide contextual data to HSRS 10 via a connection to entertainment system 32. Television (TV) 34 may also constitute a modality detection system 12, providing contextual data, e.g., what the user 14 is watching.

HSRS 10 may be configured to determine human state information and provide such information to an output system as human state outputs 18 according to a generic model, as well as apply adaptive learning to provide refined human state outputs 18 that can be continually improved over time.

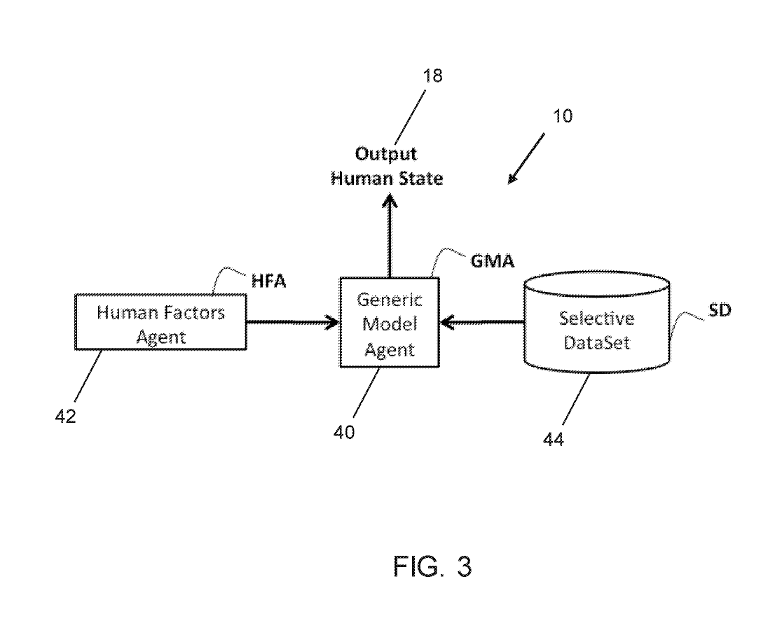

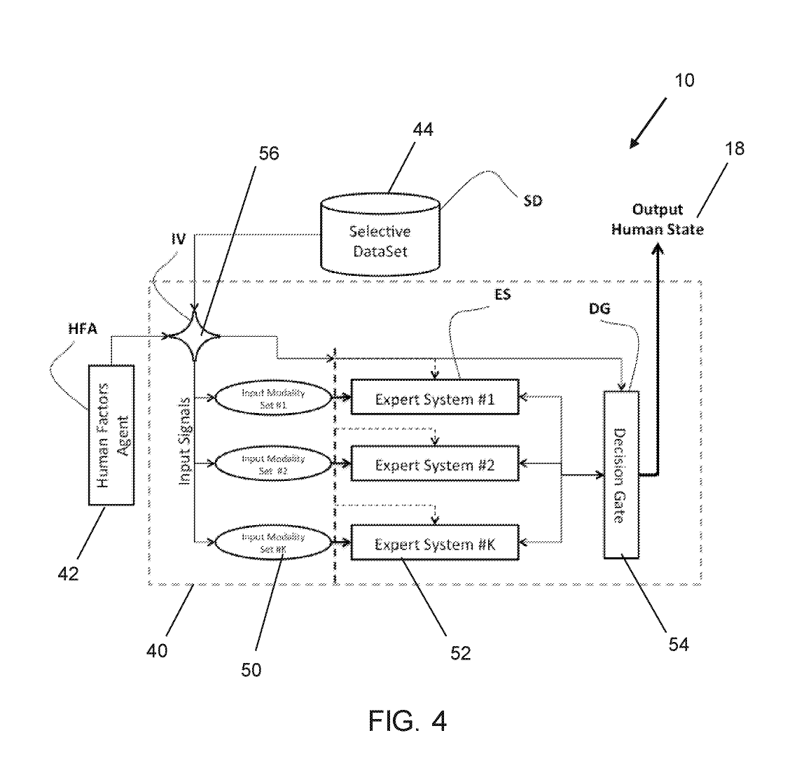

FIGS. 3 and 4 illustrate an exemplary configuration of HSRS 10 making use of a generic model. As illustrated in FIG. 3, generic model agent 40 may be used to process data from a human factors agent 42 and a selective dataset 44 to generate the human state output 18.

FIG. 4 illustrates generic model agent 40 in detail. Generic model agent 40 may include information valve 56, one or more expert systems 52, and a decision gate 54. As shown in FIG. 4, HSRS 10 may be operable to combine or fuse data from multiple expert systems 52, each processing individual input modality data sets 50 received through information valve 56. Decision gate 54 may be configured to fuse the outputs of the multiple expert systems 52 to produce fused human state information for output as a human state output 18.

Generic model agent 40 may be a multimodal mathematical model that uses the selective human state datasets from repository 44 to relate data received from modality detection systems 12 to descriptive labels associated with recorded signals stored in the human state dataset repository 44. Generic model agent 40 may use the determined relations of repository 44 to generate individual expert systems 52 that map modality data collected by modality detection systems 12 to corresponding human states. Such a mathematical model may be obtained by statistical, probabilistic, and fuzzy modeling methods that are typical in machine-learning applications.

Human factors agent 42 may include tools, devices, and/or sensors that measure human factors, e.g. modalities. For example, human factors agent 42 may include one or more modality detection systems 12. Human factors are sources of information that include cues for the purpose of the estimation/recognition of human states. Each human factor, as described above, may be referred to as a modality. Human factors agent 42 may gather data from the various modality detection systems 12 in the system. For HSRS 10, human factors are principally chosen because they are related to human states and thus may be used to infer information about human states. Human factors may be sensed and recorded qualitatively and/or quantitatively as described above.

IV 56 may receive physiological data, subjective data, environmental data, and/or contextual data of a subject indicative of or associated with the subject's human state from one or more modality detection systems 12 and from selective data set repository 44. Information valve (IV) 56 may be a control system that processes data samples newly acquired from modality data detection systems 12 and data samples acquired from selective data set repository 44 into a data samples usable by expert systems 52. For example, IV 56 may remove irrelevant information in a received data sample according to an expert system's 52 required inputs. IV 56 may remove excess data detected by modality detection systems 12 and or contained in stored data of repository 44 before passing the information to the appropriate expert system 52. IV 56 may also be configured to route the processed personal data to the appropriate expert system 52 as modality data.

In some implementations, IV 56 may use the selective dataset repository 44 to develop mathematical models for the removal and/or reduction of a noise component of data received from a modality detection system 12. In particular, IV 56 may use data from a first modality detection system 12 to remove/reduce a noise component of data received from a second modality detection system 12. For example, facial muscular activity (which may be captured through a modality detection system 12 embodied by a zygomatic electromyography sensor suite) induces a high frequency noise component on an electroencephalography signal (i.e., a brain activity measurement). In a multimodal setting where both a zygomatic electromyography signal and an electroencephalographic signal are available, the zygomatic electromyography source signal may be used to asses and discard the artifacts on the electroencephalography signals induced by the facial muscular activity via source separation techniques such as independent component analysis or other blind source separation methods. In another example, motion of the hands tends induce noise on a BVP signal measured at the wrist. However, if accelerometer sensors as other modality detection systems capture motion of the hands, then IV 56 may determine the direction of motion and the intensity of acceleration and apply filters and/or processes according to obtained information from the accelerometer sensor to obtain a more accurate pulse rate measurement.

Selective human state dataset repository 44 may include a repository of a set of human state data samples. A human state data sample (DSi) may include a combination of recorded human state signals associated with a label. The recorded human state signals may be collected via one or more modality data detection systems 12, and may be associated with descriptive labels. Descriptive labels may include quantitative and/or qualitative terms that distinguishes a specific human state from different possibilities of additional human states. The choice of descriptive labels may be set according to application context and the predefined human states.

A data sample may also include descriptive meta-information. Descriptive meta-information may include contextual information of the data sample so that it describes the context in which the signals were recorded subjective parameters that include the information of the person whose signal was recorded in the sample. A selective human state dataset of repository 44 may be defined as SD={DSᵢ: DSᵢ=({recorded signals}, descriptive label, {descriptive meta-information})}.

Expert systems 52 may be trained for the prediction of human states given a particular set of signals as input modality data. Input modality data may be received by each expert system 52 from information valve 56 after pre-processing of the relevant physiological, contextual, environmental, and/or subjective data obtained by IV 56 from one or more modality detection system 52. As discussed above, IV 56 may function to control the flow of data to each expert system 52, to increase the signal to noise ratio of the input data, and to extract noise components from the input data.

Expert systems 52 may each be initialized within generic model agent 40 and may evolve over time. A generic model may be obtained based on a set of past observations of multiple user-subjects using machine-learning techniques. In some implementations, an adaptive module (as further described below), may update the generic model based on a specific subject's feedback in different contexts and may thus generate an adaptive model inference model taking into consideration, both temporally variant and invariant parameters that either (i) have impact on human factors and/or (ii) include complementary descriptive information.

Expert systems 52 may receive modality data from the IV 56 and determine human state information based on the received modality data. As explained above, expert system 52 may be a mathematical model used by HSRS 10 that relates modality data obtained from one or more modality detection systems 12 to one or more human states. Expert system 52, once generated, may be used to associate a descriptive label (or simply a label) to previously unseen modality data. Expert system 52 may include all procedures for extracting relevant information from input modality data and mapping (via the developed model) the modality data to a proper label as human state information output. The output may then be evaluated in terms of reliability and/or accuracy with proper mathematical tools (such as coefficient of determination) as explained further below.

As illustrated in FIG. 4, generic model agent 40 may include one or more expert systems, each configured to process different sets of input modality data to determine human state information. For example, a first expert system 52 may be configured to receive modality data including information about a subject's heart rate. A second expert system 52 may be configured to receive modality data including information about a subject's breathing rate, while a third expert system 52 may be configured to receive modality data including information about a subject's galvanic skin response (indicative of a state of the sweat glands). Each piece of modality data may provide a portion of the big picture of the subject's human state, and the combination of all of the data may provide more insight than each individual set of modality data alone. Each expert system 52, receiving its own set of modality data, may determine human state information based on the received modality data. The results of each expert system 52 may be fused to produce fused human state information.

In some implementations, expert systems 52 may each receive several modality data inputs collected from multiple modality data detection systems 12 and combine these data inputs to produce combined human state information as an output.

Expert systems 52 may include programming to carry out all the steps and tools for signal processing to (i) reject noise components of input signals, (ii) standardize/normalize input signals, (iii) perform information extraction, and (iv) perform information compaction before passing the information to the mathematical model.

Generic model agent 40 may further be configured to include mathematical tools to evaluate the reliability and accuracy (performance) of individual expert systems 52 on their output (i.e. human state estimation/recognition). Such mathematical tools may include, but are not limited to, accuracy, precision, recall, F1-score, area under ROC curve, confusion matrix, root-mean-squared error (RMSE), R-squared (R2) or coefficient of determination, linear correlation, normalized mutual information.

Generic model agent 40 may also include multi-modality functionality using decision gate 54. Decision gate 54 may use the information from selective modality dataset repository 44 to fuse information content of different modalities, as processed by expert systems 52, to obtain more reliable and accurate human state outputs. Decision gate 54 may use complementary information and interactivity of different modality data to determine fused human state information which may be output as human state output 18 that is more reliable and/or more accurate than the output of individual expert systems 52. In some implementations, decision gate 54 may also use the modality data input to the expert systems 52 to produce the fused human state information. Thus, decision gate 54 may include a machine learned generic model configured to determine fused human state information based on individual human state information produced by individual expert systems 52, selective modality datasets stored in a repository 44, and input modality data provided via IV 56.

In some implementations, decision gate 54 may be programmed to produce fused human state information regardless of the combination of input modality data sets received by expert systems 52. For example, IV 56 may be configured to received data from ten different modality data detection systems 12. It may not be feasible, depending on the location and activity of the subject, for each of these ten detection systems 12 to collect data at any one time. Decision gate 54 may be programmed to accept, process, and fuse, information produced by multiple expert systems 52 based on any combination and any number of detection systems that HSRS 10 is able to obtain data from in a given circumstance.

In one implementation, fusion of multiple modalities of data input may occur at an early stage, in early fusion. In an early fusion based system, one or more modality data inputs may be fused by decision gate 54 prior to processing by a single expert system 52. Expert system 52 may process the combined modality data as described above to produce the fused human state information, based on models generated from selective modality data sets stored in data repository 44.

In such a system, one or modality data inputs may be fused into a combined modality data input prior to processing by an expert system 52. One or more combined modality data sets may be produced and processed by one or more

In another implementation, fusion of multiple modalities of data input may occur at a late stage, in late fusion. In such a system, each expert system 52 may process data from one input modality to determine human state information based on the corresponding input modality. The human state information from the multiple expert systems 52 may then be combined at decision gate 54 to produce fused human state information. In an implementation, late fusion may occur through a linear combination of expert system 52 outputs based on a set of constant coefficients as decision weights that sum up to 1. For example, assuming [a₁, a₂, a₃, . . . , aₖ] to be the output decisions of the k expert systems and [w₁, w₂, w₃, . . . , wₖ] to be constant coefficients where w₁+w₂+w₃+ . . . +wₖ=1, then the fusion of the output decisions may be calculated as w₁*a₁+w₂*a₂+w₃*a₃+ . . . +wₖ*aₖ. The decision weights may be trained via a statistical machine learning process over previously recorded data, i.e., stored in selective modality dataset repository 44.

In some implementations, decision gate 54 may perform noise reduction on input modality data to perform fusion. As discussed above, decision gate 54 may receive input modality data from IV 56. To assess the importance of each input modality data set in the fusion scheme, decision gate 54 may assess the information content of the modalities as well as the noise level on each modality. Therefore, the decision gate may identify noise types and their intensities on each modality and remove noise (if present) to associate proper weights to the human state information output by the expert systems. For example if an ECG signal is somewhat noisy, the decision gate may remove the noise before comparing its information content to the other modalities , in order to evaluate the importance and relevance of available expert system outputs.

In some implementations, hybrid late/early fusion may occur. In a hybrid fusion method, a plurality of modality data inputs may be fused by decision gate 54 prior to processing by expert systems to produce multiple combined modality data input sets. For example, given five modality data input sets, decision gate 54 may fuse three sets into a single first combined modality data input set and may fuse the remaining two sets into a single second combined modality data input set. These two combined sets may then each be processed by an appropriate expert system 52, and the human state information thus generated by the two expert systems 52 may then be fused by decision gate 54 into fused human state information. In some implementations, combined sets may also overlap.

For example, a first expert system 52 may use facial landmarks and heart-rate to recognize users' emotions, while a second expert system 52 may use speech cues only, and a third expert system 52 may use speech and face together. The results of the three systems may then be fused using a late fusion method. Thus, between the three input modalities (facial landmarks, speech cues, and heart-rates), early fusion may be used to create multiple combined input modality sets, while late fusion may be used to fuse the results of the multiple combined sets.

In some implementations of a hybrid fusion system, decision gate 54 may rely on the input modality data itself to inform the fusion of the human state information produced by the individual expert systems. In some implementations, decisions about which modalities to combine may be adaptively determined. Further, in such hybrid system, each expert system 52 may use any or all of the input modality data sets to improve the signal quality of its corresponding input modality data set.

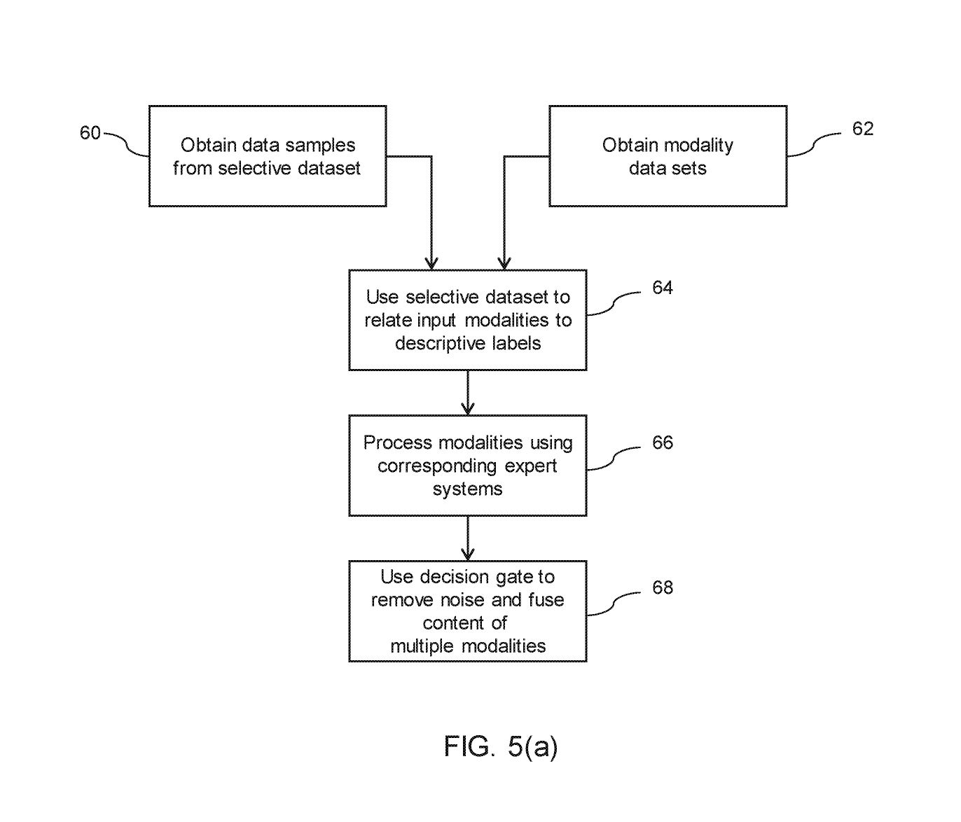

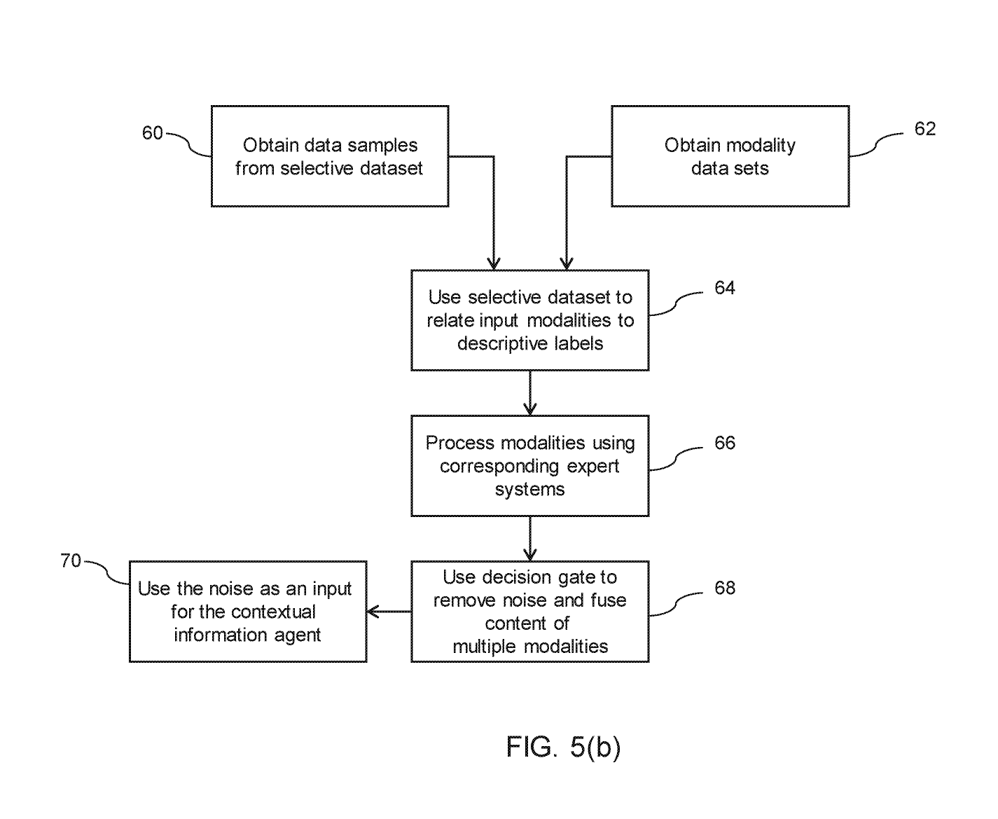

FIG. 5(a) is a flow chart illustrating exemplary operations performed by generic model agent 40 according to the configuration shown in FIG. 4 in a human state recognition method.

In an operation, at step 60, selective modality data set samples may be received and/or retrieved by IV 56 from repository 44. In an operation, at step 62, modality information input data sets may be received and/or retrieved by IV 56 from human factors agent 42.

In an operation, at step 64, generic model agent 40 may use the selective modality datasets to relate the input modality data sets to descriptive labels of the selective modality data sets to define one or more expert systems 52. Each set of relations between input modality data sets and descriptive labels may define an expert system 52. In some implementations, step 64 may be optional, and previously defined expert systems may be selected and used in the following steps.

In an operation, at step 66, generic model agent 40 may operate to process input modality data using the corresponding expert system 52. Expert systems 52 may each determine human state information according to the received modality data.

In an operation, at step 68, decision gate 54 may be used to remove noise and fuse the output human state information of multiple modalities to generate the human state information to be output as human state output 18.

As discussed above with respect to FIG. 4, multiple variations and combinations of expert system processing and fusion may be employed without departing from the scope of the disclosure. Each such variation may require the performance of steps 60-68 in a different order and/or with different inputs and outputs.

FIG. 5(b) is a flow chart illustrating example operations performed by the generic model agent 40 as explained above for FIG. 5(a) with an added step 70 for inferring some contextual information employing the extracted noise at step 68. In an operation, at step 70, generic model agent may use noise extracted at step 68 to infer contextual information associated with the modality data input sets.

In some implementations, an adaptive module may update the generic model based on a specific subject's feedback in different contexts and may thus generate an adaptive model inference model taking into consideration, both temporally variant and invariant parameters that either (i) have impact on human factors and/or (ii) include complementary descriptive information.

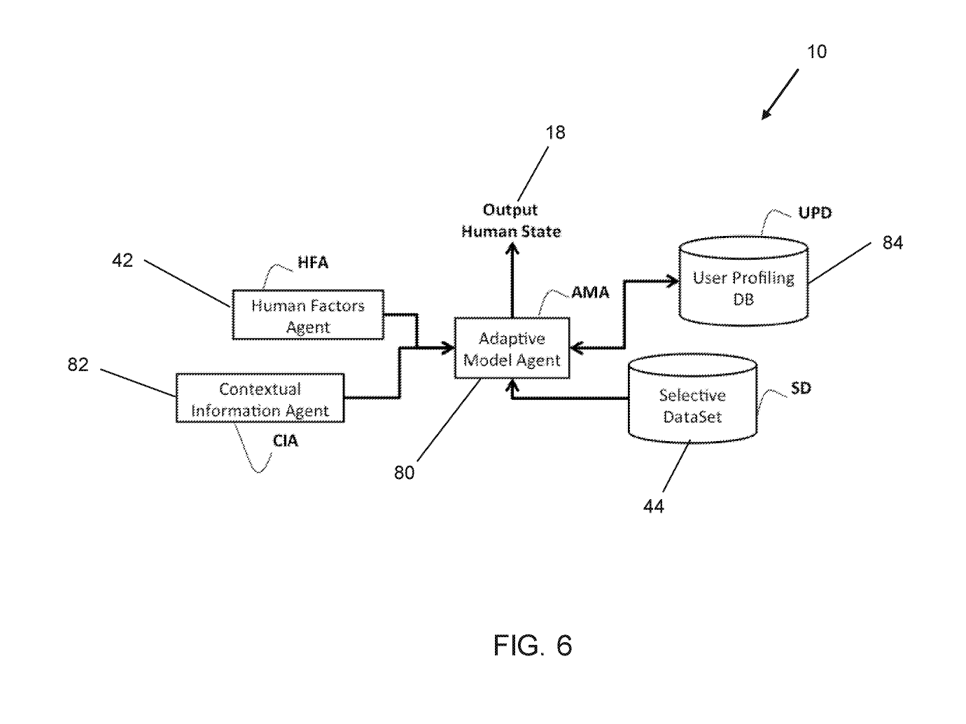

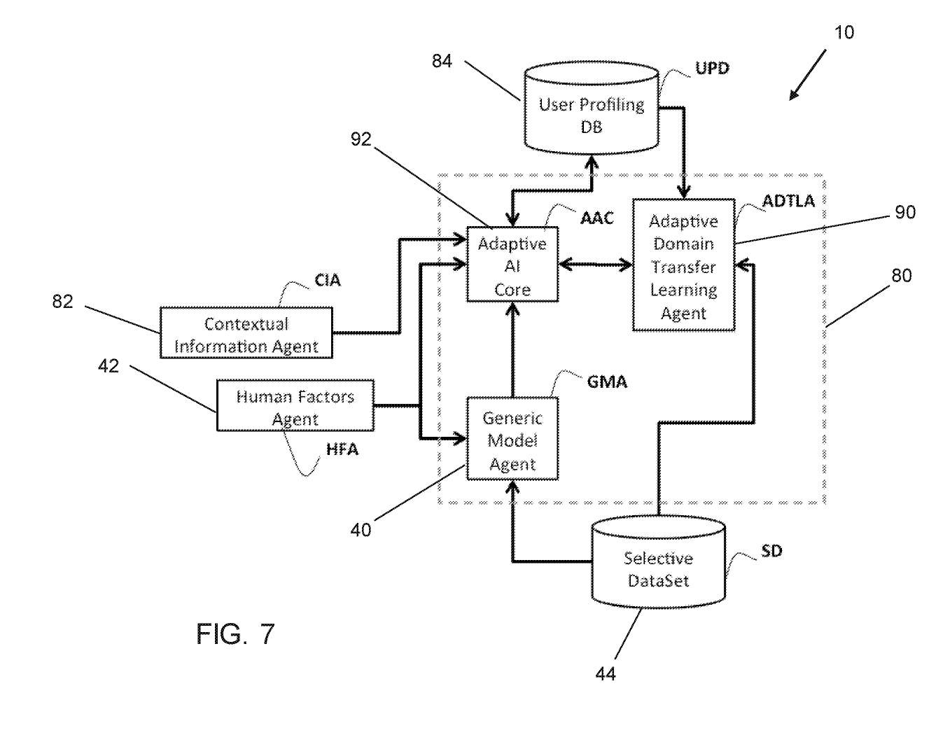

Turning now to FIGS. 6 and 7, an adaptive configuration of HSRS 10 is shown. In addition to the components illustrated in FIGS. 3 and 4, FIGS. 6 and 7 further illustrate adaptive model agent 80 which itself may include generic model agent 40, adaptive AI core 92, and adaptive domain transfer learning agent 90, contextual information agent 82, user profiling database 84, an adaptive AI core 92, and an adaptive domain transfer learning agent 90.

A generic human state recognition process, as described above, may build a mathematical model on the past observations (data samples) to predict the descriptive label of a new input record. This generic process may not take into the consideration the impact of contextual parameters (such as the location of a human). Subjective parameters such as user's personality may also not be considered in generic human state model development.

Adaptation of a generic model to different parameters that may have an impact on the human state may achieve more accurate and more reliable outputs because the system models the impact of those parameters on the final human state output 18. HSRS 10 may be configured to include multiple types of adaptive learning. In some implementations, HSRS 10 may use adaptation to contextual parameters, and, in some implementations, HSRS 10 may use adaptation to subjective parameters. For the development of adaptive schemas, for example, conditional probabilistic models including probabilistic graphical models and Bayesian network models may be employed.

To determine an adaptive inference model, HSRS 10 may record data samples (observations) that obtained from system-users (subjects). Observations include acquired input signal, contextual information (meta data), and descriptive labels. Data samples from system users may be associated with the corresponding users and may be stored in a user profiling data set repository 84. User profiling database 84 may also include a user profiling system that retains meta data provided by users such as gender, age, and ethnicity along with the information obtained from acquired data samples. Data samples associated with a user may be used for: inferring subjective parameters, both variant and invariant, inferring contextual parameters from input modalities, and developing user models including subjective and contextual parameters.

User profiling database 84 may include a model that profiles system user-subjects over time based on contextual information and subjective parameters associated with new observations and repository data samples. Such a system may use instance learning, reinforcement learning and active learning approaches for user profiling.

Contextual information agent 82 may infer contextual information of a subject that may be relevant to the human state of the subject. Contextual information agent 82 may include a mathematical model using personal data acquired by modality detection systems 12 and/or personal data obtained and provided by third party detection systems. Contextual information agent 82 may use the obtained personal data contextual information relevant to the human state. Such contextual information may be used as meta-data of modality data sample sets ad of input modality data. For example, “drinking a cup of coffee” as an action may happen in a restaurant or at an office where the location may be contextual information inferred from GPS information and accessible network IP addresses. Furthermore, the act of drinking the coffee itself may also be contextual information provided to the system. Because heart activity of a person in a neutral emotional state may be altered by simply drinking the coffee, such contextual information may facilitate the provision of more accurate/reliable human state information for a subject that has recently consumed coffee. Both location and action, in the present example, may be captured and provided to the system either by modality detection systems 12 associated with HSRS 10 and/or by third party systems capable of capturing such data.

In some implementations, contextual information agent 82 may optionally be adaptive, and, over time learn the behavior of a system user to enhance inferences of contextual information.

Adaptive model agent 80, as illustrated in FIG. 7, may include adaptive AI core 92, generic model agent 40, and adaptive domain transfer learning agent 90. Adaptive model agent 80 may include a mathematical model that uses the selective human state datasets from repository 44 as well as user profiling data sets from repository 84 to relate data received from human factors agent 42 and contextual information agent 82 to develop a machine learned inference model to determine human state information. Adaptive model agent 80 may use the developed inference model to adaptively generate individual adapted expert systems 102 to map modality data collected by modality detection systems 12 to corresponding human states.

Adaptive AI core 92 may facilitate the adaptive modeling behavior of adaptive model agent 80. Adaptive AI core may interact with contextual information agent 82, human factors agent 42, user profiling database repository 84, generic model agent 40, and adaptive domain transfer learning agent 90.

Adaptive AI core 92 may use contextual information gathered by contextual information agent 82, subjective information gathered from user profiling database repository 84 and human factors agent 82, and the outputs of generic model agent 40 to determine improved human state information to be output as human state output 18. Furthermore, adaptive AI core 92 may also provide information from user profiling database repository 84 and contextual agent 82 to generic model agent 40 to improve and adapt expert systems 52, IV 56, and decision gate 54. Thus, adaptive AI core may update the generic inference model of generic model agent 40 with any one of subjective information, contextual information, and previously determined user specific results.

Adaptive domain transfer-learning agent 90 may use the available meta-data in the selective dataset 44, meta-data associated with a new observation, and meta-data stored in user profiling database repository 84 to estimate domain transfer learning parameters.

As used herein, domain transfer refers to mapping data obtained from a first modality data detection system 12 into the scheme of a more frequently used or better understood modality data detection system 12. Unknown domains may exist where data sets are uncontrolled or semi-controlled. That is, when used outside of a laboratory, HSFS 10 may encounter modality data sets that include data captured under less than perfect conditions. Well known domains may exist when data is very-controlled or controlled. Very-controlled/controlled datasets can refer to selective modality datasets that are collected in lab environments to create mathematical models that recognize patterns over the data. Mathematical models of expert system models developed on very-controlled/controlled datasets may fail on semi-controlled/uncontrolled processes due to lack of ability of capturing the impact of uncontrolled variables on the input samples.

For example, selective dataset repository 44 may contain many data samples associating facial camera data with labels. The facial camera data including the most data samples may be images captured from a front facial view. If the only data available is from a modality detection system 12 that captures side view images, conventional systems may fail due to a lack of data. Domain transfer may be employed to map side view data samples (a relatively unknown domain) to front view samples (a relatively well known domain).

Adaptive domain transfer-learning agent 90 may include a mathematical standardization tool configured to adaptively learn how to map a (semi-controlled/uncontrolled) data entry to a data sample that is more similar to the samples available at a very-controlled/controlled dataset.

In the example provided, the system may be able to: (i) estimate the parameters of the angles of the camera or the head pose (yaw/pitch/roll); and (ii) create a corresponding mathematical transformation (e.g. projection matrix) using the estimated parameters to transform the entry from the unknown domain to the known domains available in the selective dataset.

Upon receiving a new entry from an unknown domain, past observations form different known domains may be used to (i) develop mathematical models for estimating the parameters of an unknown domain and (ii) find the mathematical transformation that maps the unknown domain to known domains.

Estimation of parameters through a mathematical model may optionally be done in an adaptive way. That is, the mathematical models may take into consideration the subjective and contextual parameters and the user's feedback to achieve a model that better estimates the transfer parameters.

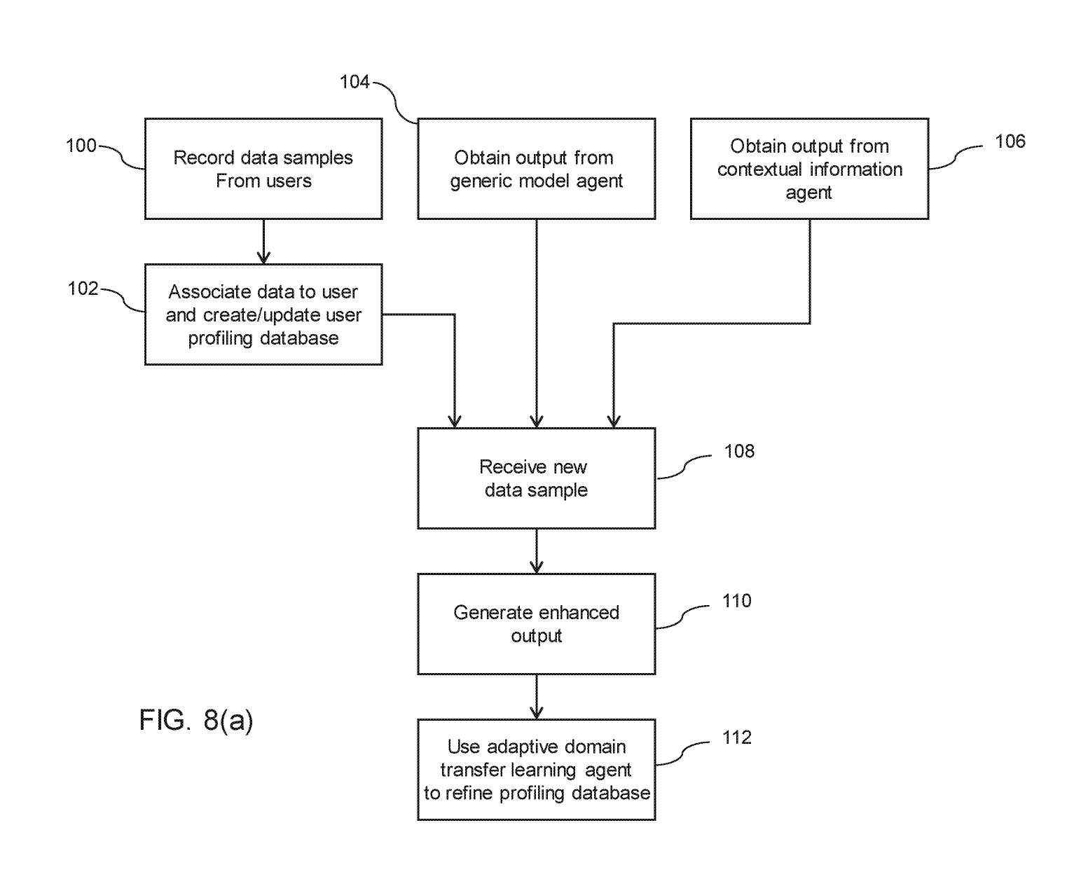

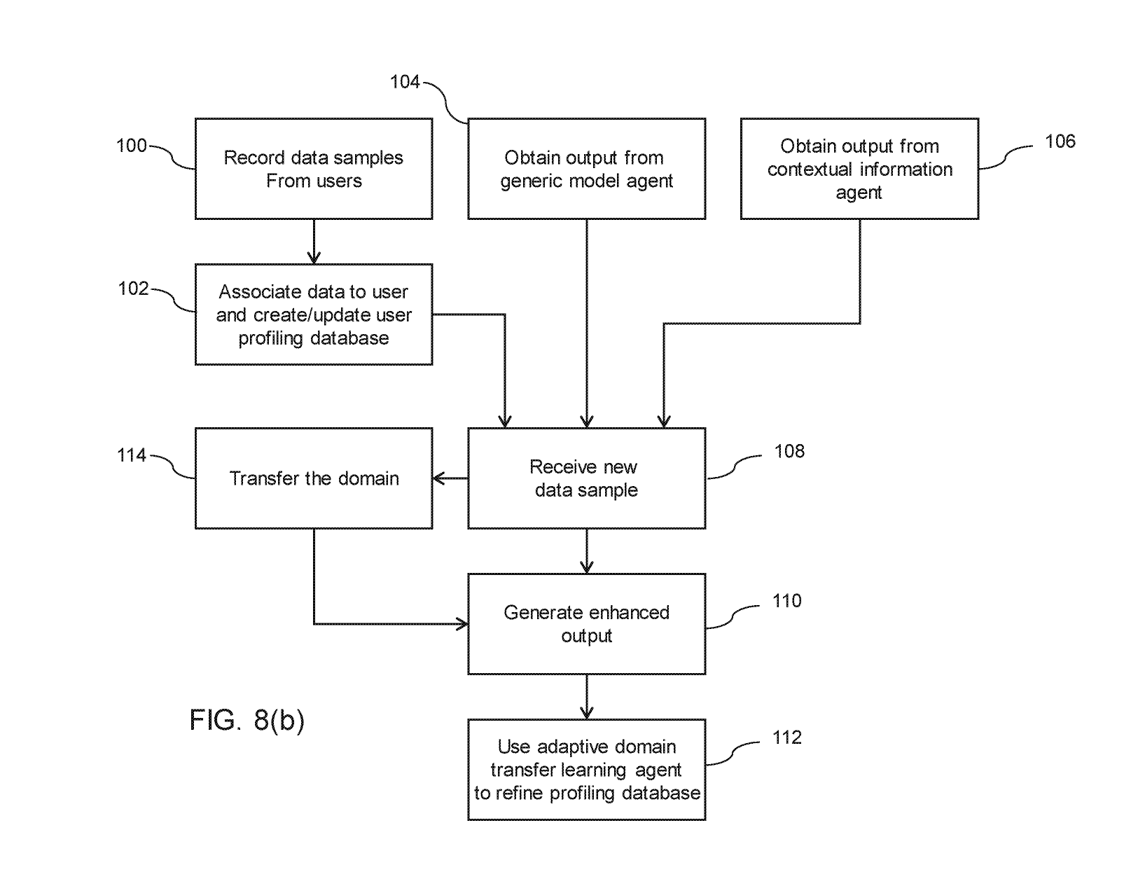

FIGS. 8(a) and 8(b) are flowcharts illustrating exemplary methods of operation of the adaptive HSFS 10 architecture illustrated in FIGS. 6 and 7.

In an operation, at step 100, modality data samples may be recorded from one or more users by one or more modality data detection systems 12. In a further operation, at step 102, the modality data samples may be associated with a profile of the corresponding user and stored in the user profiling database repository 84. Steps 100 and 102 may be performed at any time, and may be performed continuously during operation of HSFS 10. That is, any and all data samples received from any and all users may be used to build more complete profiles of system user-subjects.

In an operation, at step 108, adaptive AI core 92 may receive newly recorded personal data from human factors agent 42. Human factors agent 42 may coordinate data recording from one or more modality data detections systems 12. Human factors agent 42 may transmit personal data of the subject from one or more modalities to AI core 92 for determination of a human state output 18. To generate human state output, adaptive AI core 92 may draw data from any other aspect of the system, including at least user profiling database repository 84, generic model agent 40, and contextual information agent 82.

In an operation, at step 104, adaptive AI core 92 may receive fused human state output from generic model agent 40. Such output may include the fused output of multiple expert systems operating with a generic model, as shown, for example, in FIGS. 5(a) and 5(b). The output of generic model agent 40 may be based on the newly received modality data. As discussed above, in some implementation, the expert systems 52 of generic model agent 40 may be configured to produce human state information based on an updated inference model. That is, the machine learned inference model instantiated by expert systems 52 may be determined according to the generic information from the selective modality data set repository 44, as well as contextual information, subjective parameters, and user-specific information from user profiling database repository 84.

In an operation, at step 106, output from contextual information agent 82 may be obtained by adaptive AI core 92. Contextual information agent 82 may obtain about a user context. As discussed above, contextual information agent 82 may rely on data captured by modality data detection systems 12 and may rely on additional, third party, data sources to provide contextual information about contextual user aspects, such as location.

In an operation, at step 110, adaptive AI core 92 makes use of a user-specific adapted model to generate enhanced human state output. Adaptive AI core may use the output of generic model agent 40, information from contextual information agent 82, and information from user profiling database repository 84 to determine human state information based on modality data samples received at step 108.

In an operation, at step 112, adaptive domain transfer learning agent 90 may operate to refine user-profile data stored in user-profiling database repository 84. The user-specific human state information results determined by adaptive AI core 92 at step 110 may be used for this refinement.

FIG. 8(b) illustrates a flow chart describing a human state recognition operation including a domain transfer. In an operation, at step 114, adaptive domain transfer learning agent 92 may operate to transfer the domain of the newly received data sample. As described above, such a domain transfer may involve mapping the newly acquired data from a modality having relatively few labeled data samples stored in selective modality dataset repository 44 to a modality having a greater number of data samples stored in selective modality dataset repository 44.

There is therefore provided a system for recognizing a human state through the fusion of adaptive expert systems via a multimodal architecture. The system may feature a module that captures human factors that measures signal quality and removes the noise on an input modality with the information content of other modalities and contextual information and/or user profile. The system may also include a module that infers the context of data samples through the multimodal inputs.

The system may build an efficient model for each user over time, and may build an efficient model for a set of input modalities. The system may also be configured to do the following: use the inter-activity of input modalities to enhance their quality, use the contextual information for the adaptation procedure of each model, profile each user over time to better personalize the adaptation of each model, use contextual information for the fusion of information in the process of providing output, use user profiles and/or past observations and/or third party modules to infer contextual parameters of new data input, use user profiles and/or past observations and/or third party modules to infer invariant subjective parameters of new data input, and use user profiles and/or past observations and/or third party modules to infer variant subjective parameters of new data input.

The system may also use contextual information in an inference procedure, as well as invariant and variant subjective parameters in such an inference procedure.

The system may use the newly seen samples along with past observations, invariant/variant subjective parameters and/or contextual information to update a user's profile.

The contextual information and/or subjective parameters may also be used to infer the domain parameters of a newly seen sample. The domain parameters obtained can be used to adapt the domain of the input sample. The contextual information and/or subjective parameters and/or domain parameters can be used to learn the transfer model from one context to another context. The system may also include a user profiling system that actively learns/evolves the user profiles with newly seen samples associated with context and subjective parameters.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

What is claimed is:

1) A system for determining human state of a subject, the system comprising:
a first modality data detection system configured to recognize first personal data of the subject indicative of the human state of the subject;
a second modality data detection system configured to recognize second personal data of the subject indicative of the human state of the subject;
a computer system comprising one or more physical processors programmed by computer program instructions that, when executed, cause the computer system to:
receive first personal data and second personal data from the first modality data detection system and the second modality data detection system;
determine first modality data from the first personal data;
determine second modality data from the second personal data;
determine first human state information by a first expert system according to the first modality data;
determine second human state information by a second expert system according to the second modality data;
combine the first human state information and the second human state information by a decision gate to determine fused human state information of the subject;
provide the fused human state information of the subject to an output system.

2) The system of claim 1, wherein the computer system further includes a selective database repository including information associating recorded modality data samples with human state labels, and
the computer system is further programmed to:
generate a first generic inference model of the human subject based on information stored in the selective data repository; and
the first expert system determines the first human state information according to the first generic inference model of the human subject.

3) The system of claim 2, wherein the computer system is further programmed to:
update the first generic inference model to obtain a first adaptive inference model specific to the subject based on at least the first human state information.

4) The system of claim 3, wherein the computer system is further programmed to:
determine at least one subjective user parameter based on at least one of the first modality data and the second modality data, and
update the first generic inference model to obtain a first adaptive inference model specific to the subject based on the first human state information and the at least one subjective user parameter.

5) The system of claim 3, wherein
the first personal data recognized by the first modality data detection system includes first contextual information of the subject;
the computer system is further caused to:
determine first contextual information from the first personal data;
determine a contextual state of the human subject by a contextual information agent according to at least the first contextual information; and
update the first generic inference model to obtain a first adaptive inference model specific to the subject based on the first human state information and the contextual state of the human subject.

6) The system of claim 4, wherein
the first personal data recognized by the first modality data detection system includes first contextual information of the subject;
the computer system is further caused to:
determine the first contextual information from the first personal data;
determine a contextual state of the human subject by a contextual information agent according to at least the first contextual information; and
update the first generic inference model to obtain a first adaptive inference model specific to the subject based on the first human state information, the at least one subjective user parameter, and the contextual state of the human subject.

7) The system of claim 1, wherein the computer system is further programmed to remove noise in the second modality data based on analysis of the first modality data.

8) The system of claim 1, wherein the computer system is further programmed to remove noise in the first modality data based on at least one of contextual information and a user profile.

9) The system of claim 1, wherein the computer system further includes a selective database repository including information associating recorded modality data samples with human state labels, and
wherein the computer system is further programmed to determine the first modality data from the first personal data by a domain transfer from an unknown modality having fewer labeled data samples stored in the selective data repository to a known modality having a greater number of labeled data samples stored in the selective data repository.

10) A method of recognizing a human state of a subject, the method comprising:
recognizing first personal data of the subject indicative of the human state of the subject by a first modality data detection system;
recognizing second personal data of the subject indicative of the human state of the subject by a second modality data detection system;
receiving first personal data and second personal data from the first modality data detection system and the second modality data detection system by a computer system comprising one or more physical processors programmed by computer program instructions;
determining, by the computer system, first modality data from the first personal data;
determining, by the computer system, second modality data from the second personal data;
determining, by the computer system, first human state information by a first expert system according to the first modality data;
determining, by the computer system, second human state information by a second expert system according to the second modality data;
combining, by the computer system, the first human state information and the second human state information by a decision gate to determine fused human state information of the subject;
providing, by the computer system, the fused human state information of the subject to an output system.

11) The method of claim 10, further comprising
generating, by the computer system, a first generic inference model of the human subject based on information stored in a selective data repository, the selective database repository including information associating recorded modality data samples with human state labels; and
determining, by the computer system, the first human state information according to the first generic inference model of the human subject.

12) The method of claim 11, further comprising updating the first generic inference model to obtain a first adaptive inference model specific to the subject based on at least the first human state information.

13) The method of claim 12, further comprising determining at least one subjective user parameter based on at least one of the first modality data and the second modality data, and
updating the first generic inference model to obtain a first adaptive inference model specific to the subject based on the first human state information and the at least one subjective user parameter.

14) The method of claim 12, wherein the first personal data recognized by the first modality data detection system includes first contextual information of the subject; and the method further comprises
obtaining first contextual information from the first personal data;
obtaining first contextual information of the subject by the first modality data detection system;
determining a contextual state of the human subject by the computer system according to at least the first contextual information; and
updating the first generic inference model to obtain a first adaptive inference model specific to the subject based on the first human state information and the contextual state of the human subject.

15) The method of claim 13, wherein the first personal data recognized by the first modality data detection system includes first contextual information of the subject; and the method further comprises
obtaining first contextual information from the first personal data;
obtaining first contextual information of the subject by the first modality data detection system;
determining a contextual state of the human subject by the computer system according to at least the first contextual information; and
updating the first generic inference model to obtain a first adaptive inference model specific to the subject based on the first human state information, the contextual state of the human subject, and the at least one subjective parameter.

16) The method of claim 10, further comprising removing noise in the second modality data based on analysis of the first modality data.

17) The method of claim 10, further comprising removing noise in the first modality data based on at least one of contextual information and a user profile.

18) The method of claim 10, further comprising determining the first modality data from the first personal data by a domain transfer from an unknown modality having fewer labeled data samples stored in the selective data repository to a known modality having a greater number of labeled data samples stored in a selective data repository, the selective database repository including information associating recorded modality data samples with human state labels.

19) A system for determining human state of a subject, the system comprising:
a first modality data detection system configured to recognize first personal data of the subject indicative of the human state of the subject;
a computer system comprising a selective database repository including information associating recorded modality data samples with human state labels and one or more physical processors and programmed by computer program instructions that, when executed, cause the computer system to:
receive the first personal data from the first modality data detection system;
determine first modality data from the first personal data;
generate a first generic inference model of the human subject based on information stored in the selective data repository;
determine first human state information by a first expert system according to the first modality data based on the generic inference model;
provide the first human state information of the subject to an output system.

20) The system of claim 19, wherein the computer system is further programmed to:
determine at least one subjective user parameter based on at least one of the first modality data, and
update the first generic inference model to obtain a first adaptive inference model specific to the subject based on the first human state information and the at least one subjective user parameter.
